(19) United States
(12) Patent Application Publication
(10) Pub. No.: US 2007/0259625 A1
(43) Pub. Date: Nov. 8, 2007

(54) INTEGRATED SPECTRUM ANALYZER AND VECTOR NETWORK ANALYZER SYSTEM

(75) Inventors: Michael Tolaio, Scotts Valley, CA (US); Gerald Patrick Murphy, San Jose, CA (US)

Correspondence Address: ISHIMARU & ZAHRT LLP, 333 W. EL CAMINO REAL, SUITE 330, SUNNYVALE, CA, 94087, US

(73) Assignee: SUNRISE TELECOM INCORPORATED, San Jose, CA (US)

(21) Appl. No.: 11/746,057

(22) Filed: May 8, 2007

Related U.S. Application Data
(60) Provisional application No. 60/746,764, filed on May 8, 2006.

(51) Int. Cl. H04B 17/00

(52) U.S. Cl. 455/67.11

(57) ABSTRACT

An integrated spectrum analyzer and vector network analyzer system is provided including: providing a spectrum signal in a spectrum analysis mode of operation; processing the spectrum signal through a conversion process to provide a scaled analog signal for analog-to-digital conversion; providing a vector signal in a vector network analysis mode of operation in reverse through the conversion process; and processing the vector signal for analog-to-digital conversion.

### CROSS-REFERENCE TO RELATED APPLICATIONS

This application claims the benefit of U.S. Provisional Patent Application Ser. No. 60/746,764, filed May 8, 2006.

### TECHNICAL FIELD

The present invention relates generally to wireless communication, and more particularly to a system for testing cellular telephone base stations.

### BACKGROUND ART

Cell phones have become almost universal in everyday use and their numbers are increasing everyday. To support all these telephones, more and better cellular telephone base stations and antennas are constantly being built.

Telecommunications equipment traditionally has been offered with a significant number of features allowing on-line system test and operational maintenance surveillance. These features allow economical system operation, administration and maintenance (OA&M) since routine system testing and monitoring must be performed on a regular basis on the base station and any remote antennas. A number of tests must be performed and service provider technical staff must carry and maintain numerous pieces of test equipment in order to address these tasks.

During and after initial installation of a telecommunications system, determining the integrity of a base station antenna is an important concern. The receive antenna return loss test is a diagnostic measurement routinely performed on various cellular base stations, which provides a reasonable verification of sustained antenna integrity. This test quantifies the reflection characteristics of an antenna in order to detect whether the antenna is functioning within desired parameters.

The reflection coefficient of the antenna is the ratio of radio frequency (RF) power reflected from the antenna to the RF power applied to the antenna. A reflection coefficient having a value close to zero (0) indicates that very little RF power is reflected and that the antenna is functioning properly. A reflection coefficient having a value close to one (1) indicates that most of the RF power is reflected and that the antenna is transmitting poorly with virtually zero RF power. Transmission of very low RF power indicates problems with the antenna or the cabling between the antenna transmitter, receiver, and the cellular base station, known as the backhaul.

Network analyzers measure the antenna return loss of a cellular base station antenna by injecting a swept signal covering the antenna transmit and/or receive frequencies into the device under test (DUT), i.e., an antenna, and measuring the magnitude and phase of the signal that is reflected back. For example, typically, a technician connects the network analyzer to the feeder cable extending between the antenna and the base station, generally at the antenna at the top of a tower, and injects a signal into the feeder cable. If there are any discontinuities in the feeder cable or antenna, part of the signal may be reflected back from the feeder cable to the network analyzer.

Network analyzers are primarily utilized when the antenna being tested is not currently in use. However, if a “live” (i.e., currently in-use) test is required, the injected signal has the potential to disrupt the existing radio links between the base station and customers' mobile phones. For example, when testing a receive antenna (i.e., an antenna operating at the base station receive frequencies), as the network analyzer's source sweeps through the channel that the mobile phone's transmitter occupies (i.e., up-link channel from the mobile phone to the base station), a high level of interference is experienced at the input to the base station receiver. The interference could result in a reduction of the call quality, and possibly cause the call to drop off.

Typically, a network analyzer sends a transmit signal and monitors the signal reflections.

A spectrum analyzer on the other hand evaluates the signal frequency and strength of a signal, known or unknown. The spectrum analyzer is particularly useful in testing microwave links.

A network analyzer and a spectrum analyzer are generally separate pieces of equipment, but both are required to test cellular base stations.

Many of the newer cellular base stations communicate with transmit and receive antennas by using digital transmissions through a copper, optical fiber, or microwave link. The interface connecting the mobile switching center to the cellular base station is called the backhaul. The communication across the backhaul can be one of many different protocols, such as T1/E1, T3, ATM, SONET, OC3, Ethernet, or a similar communication protocol. In order to verify the performance and general condition of the overall cellular system, these protocols must be monitored and interpreted by both a network analyzer and a spectrum analyzer.

Additionally, most wireless network operators want to know the antenna return loss over the entire transmit frequency band to make an informed decision about the status of the antenna (e.g., return loss degradations at only some of the frequencies may indicate a slowly degrading antenna that is destined to fail and should be replaced). However, by using the base station transmitter as the source, transmitted and reflected signal measurements can only be made on the frequencies at which the base station is actually transmitting. Furthermore, without a broadband return loss measurement, the time-domain impulse response of the transmit antenna cannot be accurately calculated. The time-domain impulse response is used by time-domain reflectometry (TDR) to locate the physical position of breaks in the antenna cable. To be effective, TDR requires a broad frequency sweep.

Thus, a need still remains for an efficient network profiling system that can analyze cellular base stations and antennas simply and quickly. In view of the increasing demand for voice and data communications, it is increasingly critical that answers be found to these problems. Another aspect driving change is the ever-increasing need to save costs and improve efficiencies, makes it more and more critical that answers be found to these problems. Solutions to these problems have been long sought but prior developments have not taught or suggested any solutions and, thus, solutions to these problems have long eluded those skilled in the art.

### DISCLOSURE OF THE INVENTION

The present invention provides an integrated spectrum analyzer and vector network analyzer system including: providing a spectrum signal in a spectrum analysis mode of operation; processing the spectrum signal through a conversion process to provide a scaled analog signal for analog-to-digital conversion; providing a vector signal in a vector network analysis mode of operation in reverse through the conversion process; and processing the vector signal for analog-to-digital conversion.

Certain embodiments of the invention have other aspects in addition to or in place of those mentioned or are obvious from the above. The aspects will become apparent to those skilled in the art from a reading of the following detailed description when taken with reference to the accompanying drawings.

### BRIEF DESCRIPTION OF THE DRAWINGS

FIG. 1 is a diagram of a wireless network profiling system in accordance with an embodiment of the present invention;

FIG. 2 is a functional block diagram of the base station tester in accordance with an embodiment of the present invention; and

FIGS. 3A and 3B are a block diagram of an integrated spectrum analyzer and vector network analyzer in accordance with an embodiment of the present invention;

FIG. 4 is a flow chart of the integrated spectrum analyzer and vector network analyzer in accordance with an embodiment of the present invention.

### BEST MODE FOR CARRYING OUT THE INVENTION

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the apparatus/device are semi-diagrammatic and not to scale and, particularly, some of the dimensions are for the clarity of presentation and are shown greatly exaggerated in the drawing FIGs.

The term “horizontal” as used herein is defined as a plane parallel to the conventional plane or surface of the Earth, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane. The term “on” means there is direct contact among elements. The term “system” means both a method and an apparatus as will be evident from the context in which the term is used.

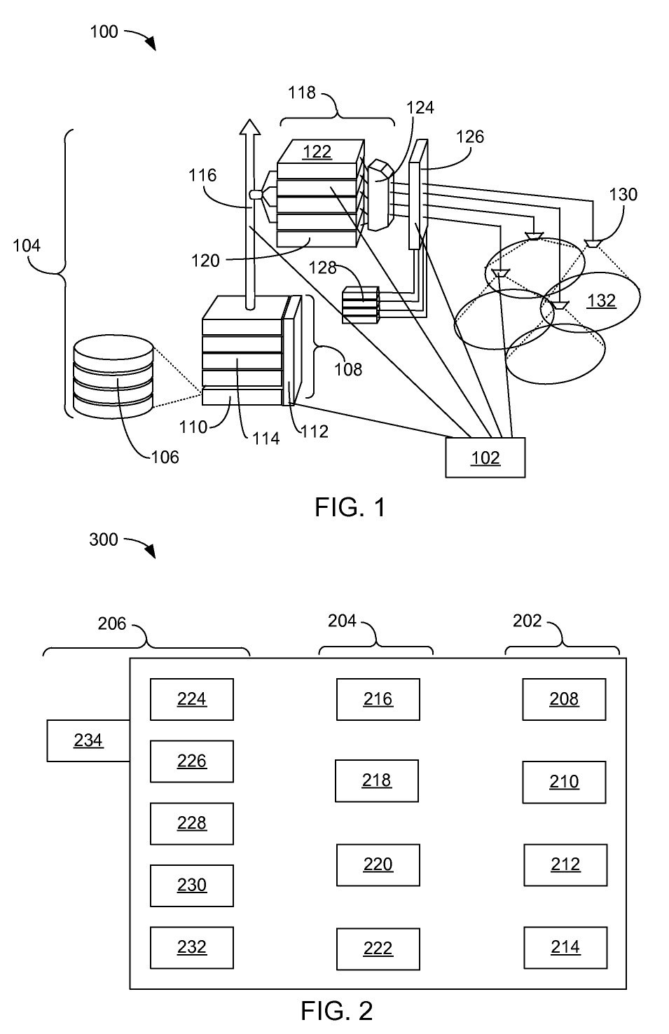

Referring now to FIG. 1, therein is shown a diagram of a wireless network profiling system 100 in accordance with an embodiment of the present invention. The diagram depicts the wireless network profiling system 100 having a base station tester 102, attached to five analysis points within a cellular base station 104. These connection points are for example only. The actual number and location of the connection(s) to the wireless network profiling system 100 may be in physically different locations or by linking radio frequency (RF) signals without a physical connection, which would allow non-invasive sampling.

The cellular base station 104 supports multiple communication functions 106, such as public safety, paging, cell phone service, two way communication and telemetry, received from a mobile switching center (MSC) (not shown). The multiple communication functions 106 enter a base station head-end 108 through a radio interface unit 110, which supplies bidirectional communication for the multiple communication functions 106.

Testing of the cellular base station 104 can be performed under a variety of circumstances at the cell site, including acceptance testing during a new installation, out-of-service testing, and in-service maintenance. During acceptance testing and in-service maintenance it is highly desirable that the cellular base station 104 be operating under normal conditions.

The base station head-end 108 includes the radio interface unit 110, a base station controller 112 and multiple base station transceivers 114. A backhaul 116, such as a T1, E1, T3, E3, ATM, OC3, Ethernet, or optical transport, connects the base station head-end 108 to a remote hub 118.

The remote hub 118 includes a packet controller 120, several communication encoder/decoders 122 and a bi-directional buffer 124. The remote hub 118 performs encoding of packet information for transmission to the appropriate communication service, such as paging, cellular communication, telemetry or two-way radio communication.

When a return signal comes from the bi-directional buffer 124, the protocol, such as cdmaOne, CDMA2000, W-CDMA (UMTS), GSM, TDMA or AMPS, is decoded by the several communication encoder/decoders 122. The bi-directional buffer 124 is connected to a Wi-Fi (wireless fidelity) access control device 126.

The Wi-Fi access control device 126 controls the signal distribution to a wireless access point 128, a passive broadband antenna 130, or a combination thereof. The wireless access point would usually be used in an indoor location with limited range. The passive broadband antenna 130 is usually used in an outdoor location where wireless coverage is spread over a wide area. The passive broadband antenna 130 has a coverage area 132. By strategically placing several of the passive broadband antenna 130, large areas, up to several square miles, can be serviced by the cellular network.

The base station tester 102 has the ability to sample and diagnose the signals at several of the key points in the wireless network profiling system 100. Radio frequency (RF) signals may be non-intrusively sampled at the passive broadband antenna 130 or the wireless access point 128. The RF signal is monitored for output power, frequency of the transmission, and distinct operation of the individual channels. The base station tester 102 has the ability to emulate a wireless handset in order to verify the receiving capabilities of both the passive broadband antenna 130 and the wireless access point 128. The base station tester 102 may attach directly to the Wi-Fi access control device 126 to verify the proper operation of the cellular access controls.

The base station tester 102 may attach directly to the remote hub 118 in order to monitor the frequency of operation and proper encoding and decoding of the packets being transferred. The internal circuitry of the base station tester 102 decodes the received signals and verifies that the communication encoder/decoder 122 is operating correctly. The base station tester 102 can identify any weakness in the remote hub 118. It is important to the operation of the wireless network profiling system 100 that any issues are addressed prior to a complete failure of the network.

The base station tester 102 can analyze the backhaul 116. For example, the condition of the material of the backhaul 116 can be analyzed by attaching the base station tester 102 to the backhaul 116. The backhaul 116 may be copper coax based or it may be optical fiber. In either case the base station tester 102 is capable of detecting the condition of the material, measuring the power of the communication, and decoding the content.

The base station controller 112 may be connected to a mobile switching center (not shown) through the radio interface unit 110. This connection may be made through an optical fiber interface, or copper cabling. The communication path consists of one or more bi-directional, high-speed data lines that incorporate a control channel and a voice channel. The base station tester 102 may be used to verify the integrity of the connection to the mobile switching center (not shown). Measurements can be made of the received signals and the processing time within the base station head-end 108.

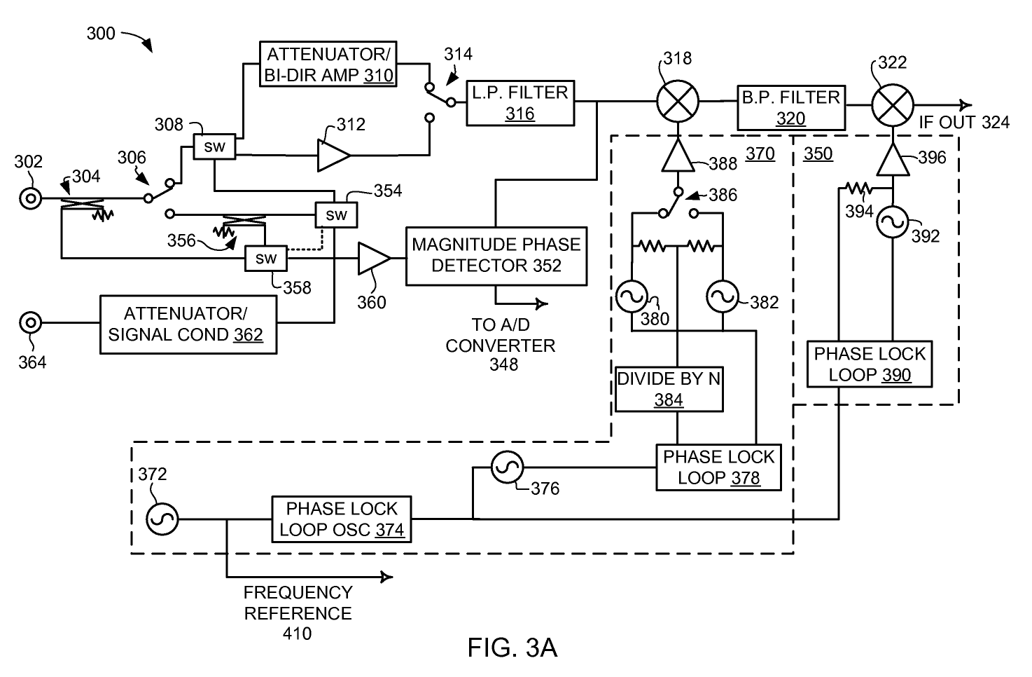

Referring now to FIG. 2, therein is shown a functional block diagram of the base station tester 102 in accordance with an embodiment of the present invention. The functional block diagram depicts the base station tester 102 having three functional groups comprising a user interface 202, a measure and control group 204 and a tester interface 206. The functional aspect of the grouping is not intended to limit or define the implementation of the individual circuits.

The user interface 202 comprises the functions available to the operator (not shown) of the base station tester 102. A graphical user interface 208 presents tester options, based on the hardware configuration, and displays graphical results of tests performed. A display driver 210 works in conjunction with the graphical user interface 208 to configure touch screen selection of tester options. A push button interface 212 is used for power on/off, cursor placement, file management, volume control, tester reset, and test initiation. A report generator 214 compiles information indicating test parameters, test results, global position during the test, and operator notes for future reference or analysis.

The measure and control group 204 comprises a digital signal processor 216 (DSP), a protocol analysis block 218, a global positioning system 220, and a mobile handset emulator 222. The digital signal processor 216 may be a single processor or a set of processors that enable the operation of the base station tester 102. The digital signal processor 216 may compare performance information against pre-loaded or user defined limits. The protocol analysis block 218, which works in conjunction with the digital signal processor 216 to identify and interpret communication details, is capable of interpreting protocols in RF, optical fiber, and backhaul communication. The RF (radio frequency) protocols that may be interpreted include CDMA, W-CDMA (UMTS), and GSM. The optical fiber and backhaul communication includes T1/T3, EL1/E3, OC3, Ethernet, among others.

Reference will now be made to both FIGS. 1 and 2 to describe the operation of parts of the base station tester 102 and the wireless network profiling system 100.

The global positioning system 220 is used to identify the absolute position that the tester was in during the execution of a test. This feature becomes important if the base station tester 102 is used for field verification of multiple base station and antenna systems that form the wireless network profiling system 100. These systems must constantly be monitored to guarantee their continued operation to support service standards established with the users of the wireless network profiling system 100.

The mobile handset emulator 222 is used to test the receive function of the wireless access point 128 and the passive broadband antenna 130. The mobile handset emulator 222 also allows the operator (not shown) to transfer voice and data information, through the wireless network profiling system 100, for storage or immediate analysis.

The tester interface 206 comprises an RF power monitor 224, a spectrum analyzer 226, a network analyzer 228, a cable analyzer 230, such as a signal generator, and an optical analyzer 232. The RF power monitor 224 is used with a peripheral antenna (not shown) to measure the transmitted RF signal from the wireless access point 128 and the passive broadband antenna 130. By capturing the power spectrum of the wireless access point 128 or the passive broadband antenna 130 at a known position relative to the transmitter, a good indication of their performance is possible. The RF power monitor 224 works in conjunction with the digital signal processor 216 to verify the transmitter is operating within expected parameters. For example, in the case of code division multiplex access (CDMA) according to the EIA IS-95 standard may contain up to 64 channels at different power levels. The base station tester 102 can perform a good/bad comparison of the transmitted signal or it can collect a detailed spectrum of the RF power for later comparison. This feature allows detection of degradation in the transmission path over time.

The spectrum analyzer 226 performs a frequency analysis of the transmitted signal from the wireless access point 128 and the passive broadband antenna 130. The spectrum analyzer 226 captures frequency peaks and distribution present in the media being analyzed. This function can be used for RF analysis as well as the backhaul 116 and optical fiber analysis. The frequencies in the transmission and receive protocols are well defined, so the base station tester 102 can detect possible degradation before a complete system failure occurs. The spectrum analyzer 226 can also be used to capture a current snapshot of the frequency performance of key components in the wireless network profiling system 100, which may be compared against previous samples for trend analysis. A trend analysis of a series of parametric information may identify a weak component prior to failure of the cellular base station 104.

The network analyzer 228 working with the digital signal processor 216 and the protocol analysis block 218 may capture and interpret the communication across the media being tested, such as the backhaul 116 or the RF energy exchanged through the wireless access point 128 or the passive broadband antenna 130. The network analyzer 228 keeps track of individual data threads sent across the media in order to display a complete picture of the performance of exchanges across the media being tested. If a series of errors are detected on the media being tested, a further analysis of the media being tested can be performed by using one of the additional functions available in the base station tester 102.

The cable analyzer 230 is available to verify the integrity of the backhaul 116, in the event that the backhaul 116 is a metal media, such as copper. The cable analyzer 230 sends a burst of RF energy into the metal media, such as copper, and monitors the media for any reflected energy. If very little RF energy is reflected, the metal media, such as copper, is operating correctly and there is no damage. If a large amount of RF energy is returned, the metal media, such as copper, is damaged somewhere along its path. The cable analyzer 230 may use a technique know as frequency domain reflectometry to determine how far away from the source the damage is located. This operation is performed by timing the interval between the transmission of the RF energy into the metal media, such as copper, and the return of the reflection from the damaged area. The standard cable and antenna system measurements include return loss, one-port cable insertion loss, and fault location.

By capturing the amount of energy that is returned, an indication of the type of damage can be predicted. A small amount of reflected RF energy can indicate that the insulation on the media has been damaged, while a near total reflection of the transmitted RF energy would indicate that the media is severed somewhere along the path. The timing of the reflection is an indication of the distance from the base station tester 102 to the damaged area.

The base station tester 102 is also capable of analyzing the backhaul 116, which is implemented as a fiber optic link. In this mode the optical analyzer 232 is utilized to check the received optical energy for frequency dispersion or lack of intensity. Either of these conditions could indicate that the optical fiber is damaged. By linking the optical analyzer 232 with the digital signal processor 216 and the protocol analysis block 218, the backhaul 116 content can be decoded and analyzed. The coordination of the resources of the base station tester provides a complete view of the operation of the wireless network profiling system 100 from commands arriving through the radio interface unit 110 through to RF energy transmitted through the passive broadband antenna 130.

The same type of monitoring can be performed through the receive path. In this case, the base station tester 102 may operate as the mobile handset emulator 222 to send RF energy into the passive broadband antenna 130 and eventually monitor that information transferred through the radio interface unit 110 between the cellular base station 104 and the mobile switching center (not shown).

An RF antenna 234 is optionally attached to the base station tester 102 in order to sample transmitted frequencies. The RF antenna 234 when used in conjunction with the digital signal processor 216 and the RF power monitor 224, can be used to verify the parametric support for industry specifications, such as the CDMA IS-95 standard which may contain up to 64 channels at different power levels. The RF antenna 234 can be used with the network analyzer 228, the digital signal processor 216 and the protocol analysis block 218 in order to capture traces of the exchanges between the cellular base station 104 and mobile users (not shown).

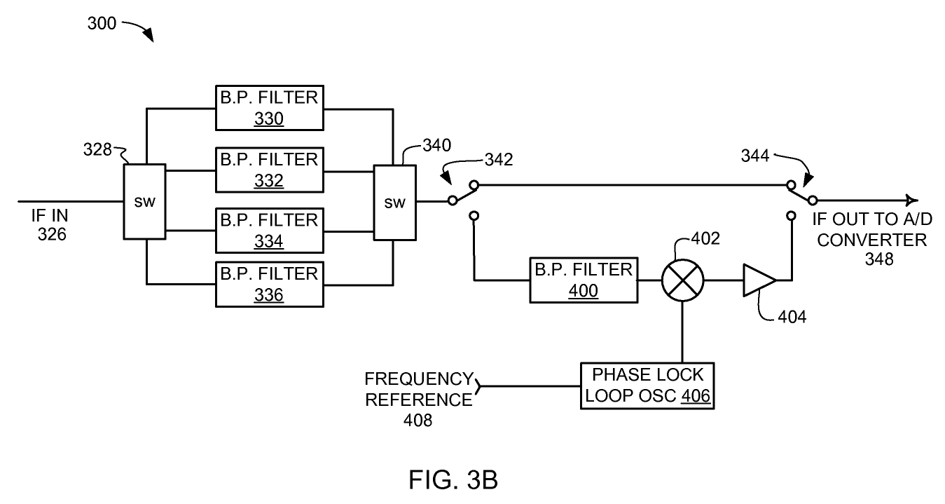

Referring now to FIGS. 3A and 3B, therein is shown an integrated spectrum analyzer and vector network analyzer system 300 of the base station tester 102 of FIG. 1. In summary, in the spectrum analyzer mode of operation, circuitry is utilized that is used in a vector network analyzer mode of operation but with the spectrum analyzer mode working as a source in the reverse direction for the vector network analyzer mode.

Starting first with the spectrum analyzer structure and operation, a spectrum signal is provided at an input port 302. The input port 302 is connected to a radio frequency (RF) coupler 304 for the spectrum analyzer mode of operation.

The RF coupler 304 is connected to a switch 306, which in one position is connected to a switch matrix 308. The switch matrix 308 is connected to an attenuator/bi-directional amplifier 310, or to a preamplifier 312. The preamplifier 312 is used to amplify low-level signals.

The attenuator/bi-directional amplifier 310 or the preamplifier 312 is connected by a switch 314 to a low pass filter 316, which is used to filter high frequencies generally above 3 gigahertz. The low pass filter 316 is connected to a mixer 318 to up-convert the signal to above 3 gigahertz. The mixer 318 is connected to a band pass filter 320 to output a signal of generally about 3440 megahertz. The band pass filter 320 is connected to a mixer 322 to down-convert the signal to approximately 70 megahertz as an intermediate frequency (IF) output 324.

Referring to FIG. 3B, an IF input 326 from the IF output of FIG. 3A is connected to a switch matrix 328. The switch matrix 328 is connected to a number of intermediate filters, which are used for filtering different resolution bandwidths for the integrated spectrum analyzer and vector network analyzer system 300.

For example, a band pass filter 330 could be for about a 6 megahertz band pass, a band pass filter 332 could be for about a 5 megahertz band pass, a band pass filter 334 could be for about a 500 kilohertz band pass, and a band pass filter 336 could be for about a 30 kilohertz band pass.

The band pass filters are connected to another switch matrix 340, which takes the combined outputs of the filters into a single radio frequency path. A switch 342 connects to a switch 344, which provides the intermediate frequency output to an analog-to-digital (A/D) converter 348 to provide a digitizer output for the spectrum analyzer.

Turning back to FIG. 3A, the spectrum analyzer becomes the source for the vector network analyzer.

A local oscillator 350 is set to a frequency of about 3440 megahertz and is provided to the mixer 322. From the mixer 322, a vector signal flows through the band pass filter 320 to the mixer 318 where the signal is down-converted to a signal between about 0 and 3 gigahertz.

A magnitude phase detector 352 samples the signal as it passes to the low pass filter 316. The output of the magnitude phase detector 352 is also provided to the A/D converter 348.

The signal from the low pass filter 316 is provided to the attenuator/bi-directional amplifier 310 where the signal is amplified and passed to the switch matrix 308. From the switch matrix 308, the signal passes to another switch matrix 354. From the switch matrix 354, the signal is provided to a RF coupler 356 where it passes through the switch 306 in the down position to the RF coupler 304 and then out of the input port 302.

From the RF coupler 356, the signal passes to another switch matrix 358. The switch matrix 358, then takes either the signal power from the RF coupler 356 or the signal power from the RF coupler 304 and passes it to a RF amplifier 360 where the signal is amplified and fed to the magnitude phase detector 352 for conditioning and output to the A/D converter 348.

The switch matrix 354 also directs the signal to an attenuator/signal conditioner 362 for output through an output port 364 for a signal source mode of operation.

Turning now to the local oscillator signals, the mixer 318 is supplied by a local oscillator 370.

The local oscillator 370 is provided with a reference signal generator 372, which provides a signal of about 20 megahertz to a phase lock loop oscillator 374. The phase lock loop oscillator 374 generates a signal of about 200 megahertz.

The signal from the phase lock loop oscillator 374 is provided to a direct digital synthesizer 376. The output of the direct digital synthesizer 376 is provided to a phase lock loop circuit 378. The phase lock loop circuit 378 is connected to oscillators 380 and 382. The outputs of oscillators 380 and 382 are sampled and fed by a divide-by-N circuit 384 back to the phase lock loop circuit 378.

The outputs of the oscillators 380 and 382 are provided to a switch 386, which takes the output of either the oscillator 380 or the oscillator 382 and provides it to an amplifier 388. The amplifier 388 provides a signal to the mixer 318 to provide the first down-conversion.

The local oscillator 350 is also provided by a signal from the phase lock loop oscillator 374 into a phase lock loop circuit 390.

The phase lock loop circuit 390 is connected to an oscillator 392. The output of the oscillator 392 is sampled through a resistor 394 and fed back to the phase lock loop circuit 390. The output of the oscillator 392 is further amplified by an amplifier 396 and fed into the mixer 322 to provide the second down-conversion.

With reference back to FIG. 3B, when the switch 342 is in its down position, modulation analysis can be performed of the second IF out of the spectrum analyzer.

The second IF signal is provided to a band pass filter 400. The signal goes from the band pass filter 400 to a mixer 402 where it is down-converted from about 70 megahertz to about 11 megahertz. The signal is then amplified by an amplifier 404 and is sent out of the switch 344 as the IF to the A/D converter 348.

The mixer 402 is down-converted by a signal from a phase lock loop oscillator 406, which receives its frequency reference from an input 408, which connects to the frequency reference output 410 of the signal generator 372 of FIG. 3A.

Basically, in the spectrum analyzer, a first converter including the local oscillator 370 and the mixer 318, translates the input frequency to a higher intermediate frequency. Traditionally, spectrum analyzers down-convert while in the current embodiment, the spectrum analyzer essentially is up-converting. The up-converted signal is filtered for image and local oscillator leakage. After variable gain, the first IF is input into a second converter including the local oscillator 350 and the mixer 322. The second converter then down converts the first IF to a second IF. Most of the analog processing and filtering for selectivity of the signal takes place at the second IF.

After the analog filtering, the signal is scaled to fit the amplitude requirements of the A/D converter 348 known as a digitizer. And the local oscillator 350 for the first converter is a multi-loop synthesizer that employs both a high spectral purity low frequency voltage controlled oscillator (VCO) and a voltage controlled crystal oscillator (VCXO) to provide the reference frequency for the microwave VCO.

The local oscillator 350 uses a narrow band VCO, which at the mixer 322 serves as the second down converter and also helps the local oscillator take the fine frequency steps to provide a coarse resolution and a fine resolution.

The spectrum analyzer works in reverse to become the source for the vector network analyzer. As the source for the vector network analyzer, the local oscillator 370 of the spectrum analyzer is repositioned in the pass band of the first IF low pass filter 316. The gain stages between the converters are bypassed, and the signal is then down-converted to act as a test source in most of the range of the vector network analyzer.

The local oscillators 370 and 350 are the same ones used in the spectrum analyzer. The synthesizers, the circuitry that relates every frequency to a common reference frequency 408, work exactly the same way. So that the vector network analyzer and the spectrum analyzer are used in the same circuit path.

After the down-conversion by the first converter, the signal may be amplified or attenuated as needed or required, and then output on one of two-ports depending on the application.

On the way to these ports the signal is passed through the directional couplers 304 and 356, which are switchable directionally. The directional couplers 304 and 356 are constructed to couple more power from the power passing through the main line to the coupled line in one direction of the power propagation than the other. This coupled power is then down-converted to a base band to characterize the outgoing signal, the signal incident on the unit-under-test and the reflected signal by the unit-under-test.

In a cable analyzer mode, the circuitry that is described earlier is connected to opposite ports of the switch matrixes 308, 354, and 358 while the other two-ports are available on the switch matrix 308 are cabled to the ports 302 and 364. The switch matrix 308 makes it possible to either connect the port 302 to the coupler circuitry and the port 364 to the through power detection, or connect the port 302 to the detection circuitry and the port 364 to the coupler circuitry at the same time. This allows for a one-port cable analyzer or vector network analyzer measurements, or in some applications, two-port measurements for gain or loss insertion based measurements.

The architecture allows full two-port characterization of a unit-under-test without the need to disconnect or reconnect the unit-under-test in the opposing direction. A base band conversion is done using quadrature, basically IQ down-conversion, which preserves the vector information on all sample signals. This makes it possible to display such information about the unit-under-test in the complex plane and also greatly reduces errors in the measurements using the vector error correction. This is typically a calibration process that is done before making measurements, and requires measurement standards, calibration measurement standards. These converters work by using the exact test signal as the local oscillator, thereby having no frequency difference between the RF and local oscillator signals resulting in zero IF or ZIF in the intermediate frequency at zero hertz. After amplification and low pass filtering, the base band signal is output to the digitizer.

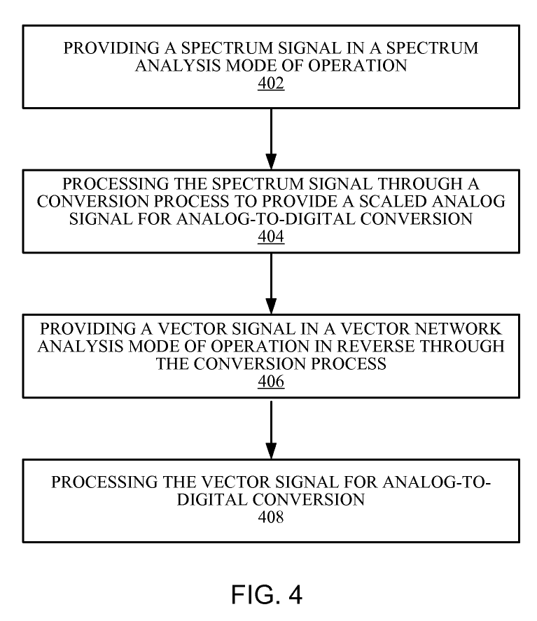

Referring now to FIG. 4, therein is shown a flow chart of an integrated spectrum analyzer and vector network analyzer system 400 in accordance with an embodiment of the present invention. The integrated spectrum analyzer and vector network analyzer system 400 includes: providing a spectrum signal in a spectrum analysis mode of operation in a block 402; processing the spectrum signal through a conversion process to provide a scaled analog signal for analog-to-digital conversion in a block 404; providing a vector signal in a vector network analysis mode of operation in reverse through the conversion process in a block 406; and processing the vector signal for analog-to-digital conversion in a block 408.

It has been discovered that combination of several analysis techniques within the base station tester enables rapid analysis of any wireless communication network issues. Capturing the performance parameters of the cellular communication network allows a trend analysis to be performed on the network components supporting the cellular network profiling system.

An aspect is that the present invention enables the rapid transmission of parametric information to an alternate site for analysis or storage. The comparison of a series of measurements from the same site can be compared for variations in the power or frequency spectrums that could predict equipment failure.

Another aspect is that the inclusion of a global positioning system chip within the base station tester allows correlation of detailed parametric information based on position of the tester relative to the passive broadband antenna.

Yet another important aspect of the present invention is that it valuably supports and services the historical trend of reducing costs, simplifying systems, and increasing performance.

These and other valuable aspects of the present invention consequently further the state of the technology to at least the next level.

Thus, it has been discovered that the wireless network profiling system method and apparatus of the present invention furnish important and heretofore unknown and unavailable solutions, capabilities, and functional aspects for analyzing and maintaining cellular communication networks. The resulting processes and configurations are straightforward, cost-effective, uncomplicated, highly versatile and effective, can be implemented by adapting known technologies, and are thus readily suited for efficiently and economically manufacturing base station test devices fully compatible with conventional manufacturing processes and technologies.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations which fall within the scope of the included claims. All matters hithertofore set forth herein or shown in the accompanying drawings are to be interpreted in an illustrative and non-limiting sense.

What is claimed is:

1. An integrated spectrum analyzer and vector network analyzer system comprising:
providing a spectrum signal in a spectrum analysis mode of operation;
processing the spectrum signal through a conversion process to provide a scaled analog signal for analog-to-digital conversion;
providing a vector signal in a vector network analysis mode of operation in reverse through the conversion process; and
processing the vector signal for analog-to-digital conversion.

2. The system as claimed in claim 1 wherein processing the spectrum signal includes processing for modulation analysis.

3. The system as claimed in claim 1 wherein processing the spectrum signal includes attenuating the spectrum signal for spectrum analysis.

4. The system as claimed in claim 1 wherein processing the vector signal includes processing to provide for a signal source mode of operation.

5. The system as claimed in claim 1 wherein processing the spectrum signal includes analog processing of the spectrum signal.

6. An integrated spectrum analyzer and vector network analyzer system comprising:
providing a signal in a spectrum analysis mode of operation;
up-converting the signal for spectrum analysis through a first conversion process to provide a first intermediate frequency signal;
filtering the intermediate frequency signal to provide a filtered intermediate frequency signal;
down-converting the filtered intermediate frequency signal through a second conversion process to provide a second intermediate frequency signal;
analog processing the second intermediate frequency signal to provide an analog signal for analog-to-digital conversion;
providing a signal in a vector network analysis mode of operation in reverse through the second conversion process to provide an intermediate source signal;
filtering the intermediate source signal to provide a filtered intermediate source signal;
down-converting the filtered intermediate source signal in reverse through the first conversion process to provide a source signal; and
magnitude phase detecting the source signal for analog-to-digital conversion.

7. The system as claimed in claim 6 further comprising:
filtering the analog signal to provide a filtered analog signal; and
down-converting the filtered analog signal for analog-to-digital conversion for modulation analysis.

8. The system as claimed in claim 6 further comprising attenuating the spectrum signal for spectrum analysis.

9. The system as claimed in claim 6 further comprising attenuation and signal conditioning for the source signal to provide for a signal source mode of operation.

10. The system as claimed in claim 6 wherein the analog processing includes filtering using a plurality of band pass filters.

11. An integrated spectrum analyzer and vector network analyzer system comprising:
input circuitry for providing a spectrum signal in a spectrum analysis mode of operation;
converter circuitry for processing the spectrum signal through a conversion process to provide a scaled analog signal for analog-to-digital conversion;
signal generation circuitry for providing a vector signal in a vector network analysis mode of operation in reverse through the conversion process; and
output circuitry for processing the vector signal for analog-to-digital conversion.

12. The system as claimed in claim 11 wherein the converter circuitry for processing the spectrum signal includes circuitry for processing for modulation analysis.

13. The system as claimed in claim 11 wherein the converter circuitry for processing the spectrum signal includes circuitry for attenuating the spectrum signal for spectrum analysis.

14. The system as claimed in claim 11 wherein the output circuitry for processing the vector signal includes circuitry for processing to provide for a signal source mode of operation.

15. The system as claimed in claim 11 wherein the converter circuitry for processing the spectrum signal includes circuitry for analog processing of the spectrum signal.

16. An integrated spectrum analyzer and vector network analyzer system comprising:
input circuitry for providing a spectrum signal in a spectrum analysis mode of operation;
up-converter circuitry for up-converting the signal for spectrum analysis through a first conversion process to provide a first intermediate frequency signal;
first filtering circuitry for filtering the intermediate frequency signal to provide a filtered intermediate frequency signal;
down-converter circuitry for down-converting the filtered intermediate frequency signal through a second conversion process to provide a second intermediate frequency signal;
analog processing circuitry for analog processing the second intermediate frequency signal to provide an analog signal for analog-to-digital conversion;
signal generation circuitry for providing a vector signal in a vector network analysis mode of operation in reverse through the second conversion process to provide an intermediate source signal;
second filtering circuitry for filtering the intermediate source signal to provide a filtered intermediate source signal;
the up-converter circuitry for down-converting the filtered intermediate source signal in reverse through the first conversion process to provide a source signal; and
phase detector circuitry for magnitude phase detecting the source signal for analog-to-digital conversion.

17. The system as claimed in claim 16 further comprising:
further filtering circuitry for filtering the scaled analog signal to provide a filtered analog signal; and
further down converter circuitry down-converting the filtered analog signal for analog-to-digital conversion for modulation analysis.

18. The system as claimed in claim 16 further comprising attenuator circuitry for attenuating the spectrum signal for spectrum analysis.

19. The system as claimed in claim 16 further comprising attenuation and signal circuitry for conditioning for the source signal to provide for a signal source mode of operation.

20. The system as claimed in claim 16 wherein the analog processing circuitry includes further filtering circuitry using a plurality of band pass filters.
